(19) United States
(12) Patent Application Publication
(10) Pub. No.: US 2025/0027573 A1
(43) Pub. Date: Jan. 23, 2025

(54) A VALVE AND A METHOD FOR CONTROLLING A PRESSURE DIFFERENCE BETWEEN A FLUID ON AN INSIDE AND AN OUTSIDE OF A CHAMBER

(71) Applicant: Cubility AS, SANDNES (NO)

(72) Inventors: Arne Malmin, SANDNES (NO); Arne Thomas Haaland, SANDNES (NO)

(73) Assignee: Cubility AS, SANDNES (NO)

(21) Appl. No.: 18/713,038

(22) PCT Filed: Nov. 30, 2022
(86) PCT No.: PCT/NO2022/050275

§ 371 Date: May 23, 2024

(30) Foreign Application Priority Data
Dec. 17, 2021 (NO) 20211524

(51) Int. Cl. F16K 17/196

(52) U.S. Cl. CPC F16K 17/196

(57) ABSTRACT

A valve, an assembly having the valve, and a method for controlling a pressure difference between fluids on an inside and on an outside of a wall defining a portion of a chamber, the valve having: a lever and a fulcrum element a first cap having a sealing surface facing the lever and configured for sealing a first aperture in a portion of the wall; a second cap having a sealing surface facing away from the lever and configured for sealing a second aperture in a portion of the wall of the chamber.

### CROSS-REFERENCE TO RELATED APPLICATIONS

This application is the U.S. national stage application of International Application No. PCT/NO2022/050275, filed Nov. 30, 2022, which international application was published on Jun. 22, 2023, as WO 2023/113607 in the English language. The International Application claims priority to Norwegian patent application No. 20211524, filed Dec. 17, 2021. The international application and Norwegian application are both incorporated herein by reference, in their entirety.

### FIELD

The present disclosure is related to a valve. More particularly, the disclosure is related to a valve for controlling a pressure difference between fluids on an inside and on an outside of a wall defining a portion of a chamber.

### BACKGROUND

The chamber in which the valve is to be used may typically be a fluid conduit or a vessel. The fluid within the chamber may have a pressure being higher or lower than an ambient pressure. Thus, the chamber may for example be a “vacuum” chamber or a pressure chamber. Independently of being a vacuum chamber or a pressure chamber, the chamber is operatively connected to a pressure-generating device for providing the desired pressure. In what follows, the pressure generating device will be denoted pump, although the pressure-generating device may also be provided by a liquid column.

A pump device for providing a vacuum or positive pressure, may be controlled by means of for example a pressure sensor communicating with a control device activating or deactivating the pump in response to a pre-set value. However, in an event of a control device or a sensor failing, a high-capacity pump may result in an implosion of a chamber, or explosion of a pressure chamber.

Publication US2010/0148107 A1 discloses a valve arrangement having an annular housing with valve seat and a two-part valve plate that is rotatable about an axis. The seat is in the form of a disk including two adjacent openings with a web between and the axis is parallel to the web. The two parts of the valve plate are next to each other with their planes parallel and offset in a perpendicular direction. They are connected to each other through one of the openings by a connection piece extending through the one opening. In a closed position for the valve, the valve plate parts are respectively positioned on opposite sides of the valve seat and cover and seal the respective openings due to a seal that is between the valve plate parts and the valve seat.

There is therefore a need for a valve configured for pressure relief or “puncture” a chamber when a pressure within the chamber raises above or becomes lower than a predetermined value. There is further a need for a fully mechanical and autonomous valve that is operationally reliable, and that is retrofittable and provides an instantaneous pressure relief at a pre-set value.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect of the invention, there is provided a valve for controlling a pressure difference between fluids on an inside and on an outside of a wall defining a portion of a chamber, the valve comprising:
a lever having a first end portion and a second end portion, and a fulcrum element arranged between the first end portion and the second end portion,
a first cap operatively connected to the first end portion of the lever, the first cap having a sealing surface facing the lever and configured for sealing a first aperture in a portion of the wall of the chamber when the valve is in a closed position;
a second cap operatively connected to the second end portion of the lever, the second cap having a sealing surface facing away from the lever and configured for sealing a second aperture in a portion of the wall of the chamber when the valve is in a closed position.

The effect of providing the first cap having a sealing surface facing the lever and the second cap having a sealing surface facing away from the lever, is that the first cap and the second cap is operated simultaneously in response to a pivoting movement of the lever with respect to the fulcrum element. The fulcrum element provides a fulcrum of the lever.

A position of the lever, and thus a position of the first cap and the second cap with respect to the wall, depends on a torque or moment on either side of the fulcrum of the lever. The moment on either side of the fulcrum depends at least on a fluid pressure acting on an effective area of the first cap and the second cap, and on a moment arm of the resulting force from each of the first cap and the second cap. The difference in effective area of the first cap and the second cap is one controlling factor of a differential pressure at which the valve opens. Thus, the valve may be configured for desired needs by a simple and reliable design.

The valve may be provided with a biasing means configured for providing an additional torque on the lever. Providing the valve with a biasing means has the effect that the valve may be adapted to required or desired changes with respect to opening and closing pressure of the valve, by selecting desired characteristics of the biasing device.

In one embodiment is the biasing means configured for urging the first cap and the second cap towards the wall of the chamber. This has the effect that the biasing means facilitates closing of an open valve when a pressure difference becomes less than a predetermined value, independently of any orientation of the valve.

The biasing means may be in the form of a spring.

In one embodiment, when a valve according to the invention is to be arranged in a specific orientation, the biasing means may be provided by a mass element configured for providing a torque with respect to the fulcrum element. The mass element may for example be provided by means of one of the first cap and the second cap.

The first cap and the second cap may be adapted to a form of the first aperture and the second aperture, respectively. At least one of the first aperture and the second aperture may have a non-circular form allowing at least one of first cap and the second cap to be passed through the first aperture or the second aperture. This has the effect that the valve may be assembled independently of any access to both sides of the wall of the chamber when mounting the valve to the wall of the chamber.

An area of the sealing surface of the first cap of the valve may be different from an area of the sealing surface of the second cap. This has the effect that the pressure acting on the first cap and the second cap will result in different forces. Different forces may result in different moment with respect to the fulcrum member.

The valve may comprise a wall element provided with the first aperture and the second aperture, wherein the wall element may be configured for overlapping a perimeter of an opening provided in the wall of the chamber. Thus, the wall element may form part of the valve. Providing a wall element forming part of the valve has the effect that the valve may be fully assembled for example by the manufacturer, and the valve can be brought into an operating position by securing the wall element comprising the valve overlappingly to the perimeter of the opening to the chamber wall. Since the wall element is configured for overlapping a perimeter of an opening provided in the wall of the chamber, the wall element forms, when secured to the wall of the chamber, also a portion of the wall of the chamber.

In a second aspect of the invention, there is provided a valve assembly comprising the valve according to the first aspect of the invention, and a wall element configured for overlapping a perimeter of an opening provided in the wall defining a portion of the chamber.

In a third aspect of the invention there is provided a method for controlling a pressure difference between fluids on an inside and on an outside of a wall defining a portion of a chamber, the method comprises:
providing a valve according to the first aspect of the invention;
providing fluid communication through a portion of a wall of the chamber; and
securing the valve to the wall of the chamber so that fluid is communicated into our out of the chamber via the first aperture and the second aperture when a pressure difference between fluids on an inside and on an outside the chamber exceeds a predetermined level and the valve opens, and so that fluid is prevented from being communicated through the wall of the chamber when the valve is closed.

The valve according to the invention may for example be used in a chamber in the form of a gas duct, such as an air duct, operatively connected to a pump device for moving the air through the duct. The valve is found to be suitable for use as a safety device for being activated (to open) in an event of a malfunctioning pump generating an undesired pressure within the duct, or any other chamber subject to an under- or overpressure.

### BRIEF DESCRIPTION OF THE DRAWINGS

In the following is described examples of preferred embodiments illustrated in the accompanying drawings, wherein:

FIG. 1 shows a perspective view of an embodiment of a valve according to the invention operatively connected to a wall portion a chamber;

FIG. 2 shows in smaller scale and partly exploded a perspective view of the valve in FIG. 1, wherein the valve comprises a wall element for being secured to a portion of a wall of a chamber;

FIG. 3 shows in smaller scale an exploded view of the valve in FIG. 2, and a protective cover;

FIG. 4 shows the valve in FIG. 1 operatively connected to a horizontal wall portion of a chamber, and provided with weight elements; and

FIG. 5 shows an embodiment of the valve connected to a chamber via a wall element as shown in FIGS. 2 and 3, and wherein the valve is provided with a displaceable lever.

### DETAILED DESCRIPTION OF THE DRAWINGS

Any positional indications refer to the position shown in the figures.

In the figures, same or corresponding elements are indicated by same reference numerals. For clarity, some elements are in some of the figures without reference numerals.

For illustrative reasons, the relative proportions of some of the elements may be somewhat distorted.

In the figures, reference numeral 1 denotes a valve according to the invention. The valve 1 is configured for controlling a pressure difference between fluids, typically gas, on an inside and on an outside of a wall CW or a wall element 50 of a chamber. The chamber may for example be a channel for a flowing fluid having a pressure being lower than or higher than ambient pressure. The ambient pressure may for example be atmospheric pressure.

The valve 1 comprises a lever 3 having a first end portion 5 and a second end portion 7 opposite the first end portion 5. The lever 3 is pivotably secured to a fulcrum member 10 projecting from a surface of the wall CW or the wall element 50 to provide a fulcrum between the first end portion 5 and the second end portion 7 of the lever 3. In the embodiments shown, the fulcrum member 10 is arranged about midways between the first end portion 5 and the second end portion 7.

The valve 1 further comprises a first cap 20 pivotably connected to the first end portion 5 of the lever 3 via a pivot connection 22 comprising an ear- and bolt connection that will be appreciates by a person skilled in the art. The first cap 20 has a sealing surface 24 facing the lever 3. The sealing surface 24 comprises an annular sealing element 25 secured at a periphery portion of the sealing surface 24. When the valve 1 is in a closed position, the first cap 20 is configured for sealing a first aperture A1 in a portion of a wall CW of the chamber.

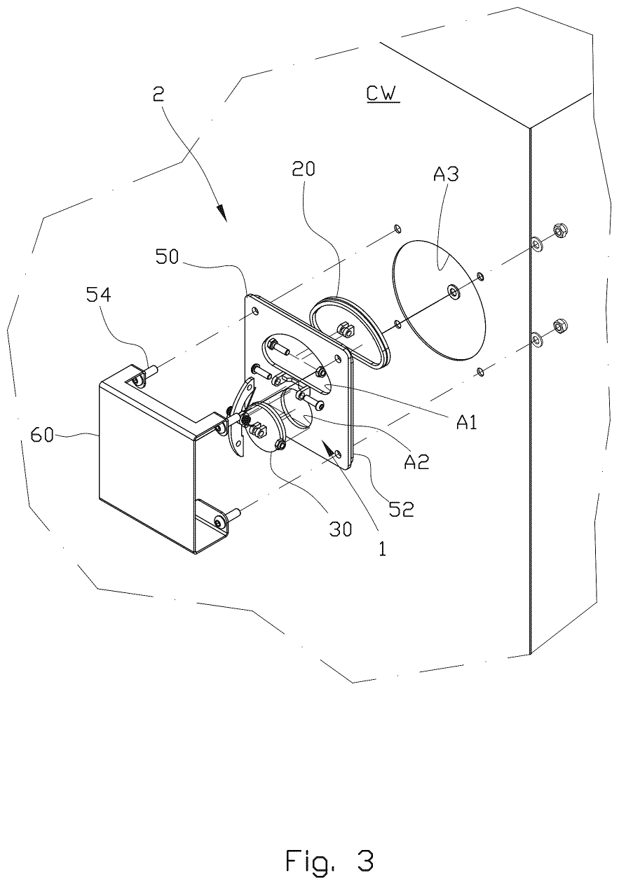

The valve 1 further comprises a second cap 30 pivotably connected to the second end portion 7 of the lever 3 via a pivot connection 32 comprising an ear- and bolt connection that will be appreciates by a person skilled in the art. The second cap 30 has a sealing surface 34 facing away from the lever 3. The sealing surface 34 comprises an annular sealing element 35 secured to a periphery portion of the sealing surface 34. When the valve 1 is in a closed position, the second cap 30 is configured for sealing a second aperture A2 (see FIG. 3) in a portion of a wall CW or a wall element 50 of the chamber.

Since the first cap 20 has a sealing surface 24 facing the lever 3, while the second cap 30 has a sealing surface 34 facing away from the lever 3, the first cap 20 and the second cap 30 in a position of use of the valve 1 are arranged on each side of the wall element CW of the chamber.

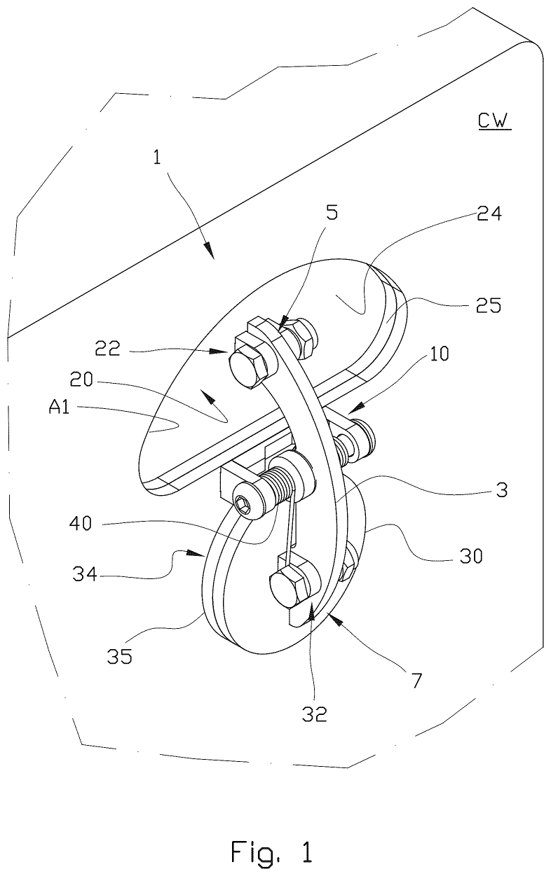

In FIG. 1, the valve 1 is operatively connected to a chamber wall CW provided with a first aperture A1 and a second aperture. The valve in FIG. 1 is shown in a closed position wherein the second aperture is covered by the second cap 30, but the second aperture in FIG. 1 is similar to the second aperture A2 shown in FIG. 3.

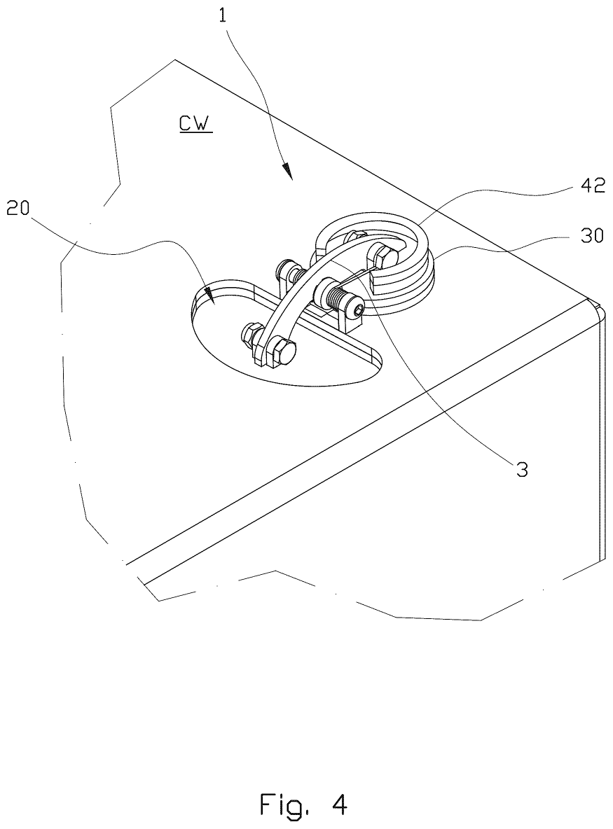

In the embodiments shown in FIGS. 1 and 4, the apertures A1 and A2 are provided by cutting away portions of the wall CW of the chamber. Further, the fulcrum member 10 is secured to the wall CW, for example by mechanical fastening means. In the embodiment shown for example in FIG. 1 the first cap 20 is configured for sealing an aperture A1 having a larger area than the aperture A2 to be covered by the second cap 30, and a portion of the valve 1 may be tread through the first aperture A1. The proportion between the aperture A1 and the aperture A2 with their appurtenant first cap 20 and second cap 30, respectively, influences a “set point” of the valve, i.e., a pressure difference at which the valve opens and at least reduces a pressure difference between an outside and an inside of the chamber.

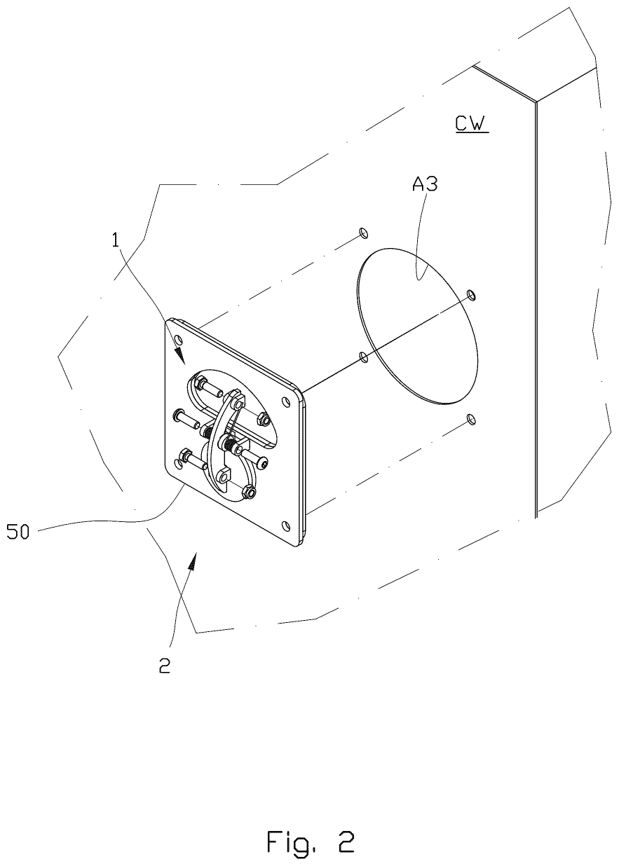

FIGS. 2, 3 and 5 show an alternative way of connecting the valve 1 to the wall CW of the chamber. In said figures the valve 1 is preassembled onto a chamber wall element 50 configured for overlapping a perimeter of an opening A3 provided in a wall CW of the chamber. Thus, the valve 1 and the wall element 50 form a valve assembly 2.

The wall element 50 is provided with the first aperture A1 adapted to the first cap 20, and a second aperture A2 adapted to the second aperture A2.

In a position of use, the first aperture A1 and the second aperture A2 of the valve assembly 2 is configured for communicating with the chamber opening A3. Thus, only one aperture (the opening A3) is required in the wall CW of the chamber for communicating a fluid through the wall CW of the chamber.

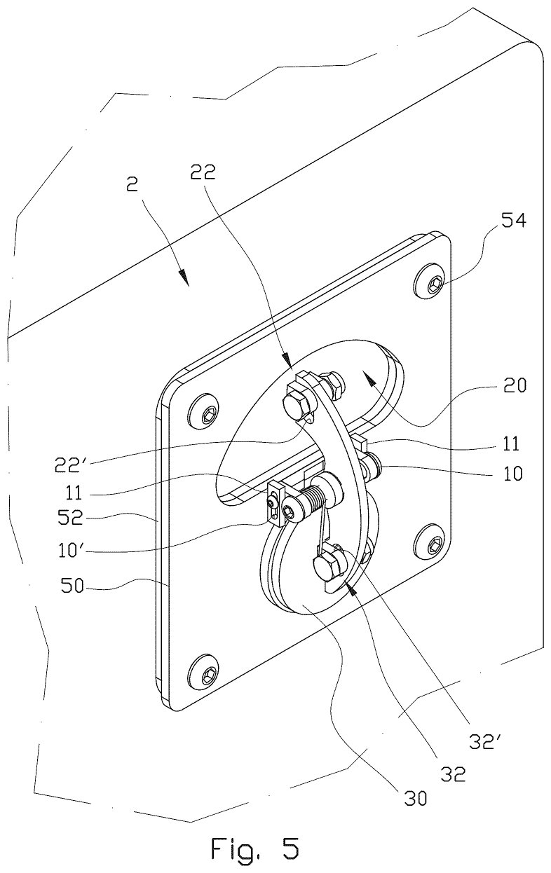

The wall element 50 of the valve assembly 2 is configured for being secured in a sealing manner to the chamber wall CW. In the embodiment shown the wall element 50 is provided with a sealing means 52 and secured to the chamber wall CW by means of screws 54 as shown for example in FIG. 5.

FIG. 3 shows a protective cover 60 configured for protecting the valve 1 against objects that may damage parts of the valve being exposed to ambient environment. In the embodiment shown, the protective cover is secured to the wall element 50 by means of screws 54. It should be noted that the protective cover 60 may also be used for protecting valve 1 operatively connected to the wall CW of the chamber, as shown in FIGS. 1 and 4.

In the embodiments shown, an effective area of the first cap 20 that in a position of use may be subject to a fluid pressure different from ambient pressure, is larger than an effective area of the second cap 30 also subject to the fluid pressure via aperture A2. Thus, when a pressure inside the chamber is lower than an ambient pressure on the outside of the chamber, pressure acting on the first cap 20 will result in a force that is larger than a force resulting from the pressure acting on the second cap 30 having a smaller effective area. Thus, the two forces will provide oppositely directed moments with respect to the fulcrum member 10.

Due to the different effective areas of the first cap 20 and the second cap 30, and the shown configuration wherein the moment arms of each cap 20, 30 are substantially equal since the fulcrum member 10 is arranged about midways between the first end portion 5 and the second end portion 7 of the lever 3 as mentioned above, the valve 1 tend to open once there is a lower pressure inside the chamber than outside the chamber.

However, to control the pressure difference upon which the valve 1 opens, a resulting, effective torque or moment should be controlled. Controlling the resulting moment can be achieved in many ways. One way is the effective areas of the first cap 20 and the second cap 30 as discussed above. Another way of controlling the resulting moment is to arrange a biasing means providing a torque. A biasing means may be a spring 40 as shown for example in FIG. 1. Alternatively, or additionally, the resulting moment may be controlled by controlling a weight of at least one of the first cap 20 and the second cap 30. Controlling a weight of at least one of the first cap 20 and the second cap 30 may be particularly effective for a valve 1 that is configured to be arranged substantially horizontally, meaning that the lever 3 is configured to pivot with respect to a substantially horizontal plane. FIG. 4 shows such a “horizontal” valve 1 provided with a weight element 42 secured to a portion of the second cap 30. In the shown example, the weight element 42 is provided by means of two horseshoe-shaped magnets arranged stacked on a top surface of the second cap 30 made from a magnetic material. In the shown example, the activation pressure of the valve 1 is adjustable by adding or removing magnets from the second cap 30. However, alternatively, or additionally to providing weight elements 42, the control of the pressure difference upon which the valve 1 opens may be provided by the weights of the first cap 20 and the second cap 30, for example by providing the second cap 30 in a denser material than the first cap 20.

A biasing means, such as a spring 40 and/or a weight element 42 is suitable also for controlling closing of the valve 1 by urging the first cap 20 and the second cap 30 towards the wall CW of the chamber or the wall element 50 of the valve assembly 2, when a pressure difference becomes less than a predetermined level. A biasing means in the form of a spring 40 operates independently of any orientation of the valve 1.

A further or an alternative way of controlling the resulting moment is to provide a lever 3 that is adjustable with respect to the fulcrum member 10, so that a longitudinal axis of the lever 3 is displaceable with respect to the fulcrum member 10 and the first cap 20 and the second cap 30. A distance between the fulcrum member 10 and each of the first cap 20 and the second cap 30 can be adjusted to provide a desired moment arm for the forces acting on each the first cap 20 and the second cap 30. An example of a displaceable lever 3 is shown in FIG. 5. The lever 3 is provided with two slots: a first slot 22′ for receiving a bolt for providing the pivot connection 22 for the first cap 20; and a second slot 32′ for receiving a bolt for providing the pivot connection 32 of the second end cap 30. The fulcrum member 10 is secured to the wall element 50 via a fulcrum member guide 11 that is secured to the wall element 50 for example by welding (not shown). The fulcrum member guide 11 is provided with a slot 10′ for receiving a bolt for locking the fulcrum member 10 in a desired position within the slot 10′. By displacing the lever 3 with respect to the fulcrum member guide 11, and adjusting the first cap 20 and the second cap 30 accordingly within their respective slots 22′ and 32′, the moment arm for the first cap 20 and the second cap 30 is altered. Thus, an activation pressure of the valve 1 may be “finetuned” in a simple manner.

In an alternative embodiment (not shown) is each of the first slot 22′ and the second slot 32′ replaced with at least two apertures configured for receiving its respective bolt of the pivot connections 22, 32.

When the valve 1 opens, a pressure difference between the fluids on an inside and on an outside of the chamber, will be rapidly reduced. This is because the first cap 20 and the second cap 30 allow instantaneous fluid communication through the first aperture A1 and the second aperture A2 once the lever 3 is pivoted with respect to the fulcrum member 10 and the valve 1 opens for fluid communication through the first aperture A1 and the second aperture A2. Once a pressure difference between the fluids on an inside and on an outside of the chamber is below a predetermined value, the valve 1 as shown will close.

Due to its configuration, the valve 1 opens immediately and substantially to a fully open position once a pressure difference across the valve exceeds a “set-pressure”.

The valve 1 according to the invention is relatively simple in construction, has few movable parts and is an autonomous, self-operating device that requires substantially no maintenance during it operating lifetime.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A valve for controlling a pressure difference between fluids on an inside and on an outside of a wall defining a portion of a chamber, the valve comprising:
a lever having a first end portion and a second end portion, and a fulcrum element arranged between the first end portion and the second end portion,
a first cap operatively connected to the first end portion of the lever, the first cap having a sealing surface facing the lever and configured for sealing a first aperture in a portion of the wall of the chamber when the valve is in a closed position and
a second cap operatively connected to the second end portion of the lever, the second cap having a sealing surface facing away from the lever and configured for sealing a second aperture in a portion of the wall of the chamber when the valve is in a closed position.

2. The valve according to claim 1, further provided with a biasing means configured for providing an additional torque on the lever.

3. The valve according to claim 2, wherein the biasing means is configured for urging the first cap and the second cap towards the wall of the chamber.

4. The valve according to claim 2, wherein the biasing means comprises a spring.

5. The valve according to claim 2, wherein the biasing means comprises a mass element configured for providing a torque with respect to the fulcrum element.

6. The valve according to claim 1, wherein the first cap and the second cap is adapted to a form of the first aperture and the second aperture, respectively, and wherein at least one of the first aperture and the second aperture has a non-circular form allowing at least one of first cap and the second cap to be passed through the first aperture or the second aperture.

7. The valve according to claim 1, wherein an area of the sealing surface of the first cap is different from an area of the sealing surface of the second cap.

8. The valve according to claim 1, wherein the valve comprises a wall element provided with the first aperture and the second aperture, wherein the wall element is configured for overlapping a perimeter of an opening provided in the wall of the chamber.

9. A valve assembly comprising the valve according to claim 1, wherein the valve assembly further comprises a wall element configured for overlapping a perimeter of an opening provided in the wall of the chamber.

10. A method for controlling a pressure difference between fluids on an inside and on an outside of a wall of a chamber, the method comprises:
providing a valve according to claim 1;
providing fluid communication through a portion of the wall of the chamber; and
securing the valve to the chamber so that fluid is communicated into our out of the chamber via the first aperture and the second aperture when a pressure difference between fluids on an inside and on an outside the chamber exceeds a predetermined level and the valve opens, and so that fluid is prevented from being communicated through the wall of the chamber when the valve is closed.

11. The valve according to claim 3, wherein the biasing means comprises a spring.

12. The valve according to claim 3, wherein the biasing means comprises a mass element configured for providing a torque with respect to the fulcrum element.

13. The valve according to claim 4, wherein the biasing means comprises a mass element configured for providing a torque with respect to the fulcrum element.
